(19) United States
(12) Patent Application Publication
(10) Pub. No.: US 2017/0151720 A1
(43) Pub. Date: Jun. 1, 2017

(54) ADDITIVE MANUFACTURING METHOD

(71) Applicant: Metal Industries Research & Development Centre, Kaohsiung (TW)

(72) Inventors: Che-Nan Kuo, Kaohsiung City (TW); Cheng-Wen Lin, Kaohsiung City (TW); Yu-Lun Su, Tainan City (TW); Meng-Hsiu Tsai, Kaohsiung City (TW); Sebastien Husson, Tainan City (TW); De-Chang Tsai, Kaohsiung City (TW); Cheng-Tsung Kuo, Pingtung County (TW); Ying-Cherng Lu, Kaohsiung City (TW); Ho-Chung Fu, Kaohsiung City (TW)

(21) Appl. No.: 14/953,018

(22) Filed: Nov. 27, 2015

(51) Int. Cl. B29C 67/00

(52) U.S. Cl. CPC B29C 67/0077; B33Y 10/00

(57) ABSTRACT

An additive manufacturing method is provided. A plurality of powder layers is stacked on a supporting plate in sequence. Energy beams are provided to the powder layers in sequence by using an energy source, such that each of the powder layers is at least partially shaped. The powder layers are heated by using a temperature control device, so as to control a temperature of each of the powder layers being shaped.

### BACKGROUND OF THE INVENTION

Field of the Invention

The invention relates to a manufacturing method, and particularly relates to an additive manufacturing method.

Description of Related Art

Additive manufacturing (AM) technique is also referred to as material adding manufacturing, which extracts two-dimensional (2D) contours of a plurality of layers from a three-dimensional (3D) image file, and manufactures a 3D object according to 2D data of each of the layers. Different to a conventional subtractive (material removal) manufacturing technique, the additive manufacturing technique manufactures the 3D object through layer-by-layer stacking, by which a manufacturing time and process of the 3D object with a complicated 3D structure can be shortened, so as to save plurality of processes and a time for changing processing tools or equipment, and accordingly improve manufacturing efficiency greatly.

However, since the additive manufacturing technique is to sequentially exert a high-energy beam to each powder layer stacked layer-by-layer to sinter and shape the powder layers, when the powder layer staked on the top is sintered and shaped, a shaping temperature thereof is increased due to remaining warmth of the lower processed powder layers. Therefore, the shaping temperatures of the powder layers are different to each other, such that material properties of each layer structure of the 3D object are inconsistent to cause a low manufacturing quality. Moreover, if cooling down of the processed powder layers is excessively fast in a room temperature environment, a thermal stress is liable to be accumulated to cause warping of the powder layers, which influences the subsequent stacking and processing of the powder layers.

### SUMMARY OF THE INVENTION

The invention is directed to an additive manufacturing method, by which a material property of each layer structure of a 3D object is consistent, so as to avoid accumulating excessive thermal stress to cause warping after the powder layers are processed.

The invention provides an additive manufacturing method, which includes following steps. A plurality of powder layers is stacked on a supporting plate in sequence. Energy beams are provided to the powder layers in sequence by using an energy source, such that each of the powder layers is at least partially shaped. The powder layers are pre-heated by using a temperature control device, so as to control a temperature of each of the powder layers being shaped.

In an embodiment of the invention, the step of heating the powder layers by using the temperature control device includes continually heating each of the powder layers by using the temperature control device, so as to decrease a cooling rate of each of the shaped powder layers.

In an embodiment of the invention, the step of providing the energy beams to the powder layers in sequence by using the energy source includes receiving the energy beam provided by the energy source by each of the powder layers before the powder layer is covered by another powder layer, and simultaneously heating the powder layer by the temperature control device.

In an embodiment of the invention, the supporting plate has an upper surface and a lower surface opposite to each other, and the temperature control device is disposed on the lower surface, and the step of stacking the powder layers on the supporting plate in sequence includes carrying the powder layers by using the upper surface.

In an embodiment of the invention, the temperature control device includes a resistive heating plate, and the step of heating the powder layers by using the temperature control device includes heating the powder layers by using the resistive heating plate.

In an embodiment of the invention, the step of heating the powder layers by using the temperature control device includes following steps. A temperature of top one of the powder layers is sensed by using a temperature sensing unit. The powder layers are heated by using the temperature control device according to the temperatures of the top one of the powder layers.

In an embodiment of the invention, the additive manufacturing method includes driving the supporting plate to ascend and descend relative to a working plane by using an elevating device, such that each of the powder layers is stacked and receives the energy beam provided by the energy source at the working plane.

In an embodiment of the invention, the additive manufacturing method includes respectively controlling the energy source, the temperature control device and the elevating device by using a first control unit, a second control unit and a third control unit.

In an embodiment of the invention, the additive manufacturing method includes cooling the powder layers by using a cooling device.

In an embodiment of the invention, the additive manufacturing method includes containing the powder layers on the supporting plate by using a containing tank.

According to the above descriptions, in the invention, the temperature control device is applied to control a processing temperature of each of the powder layers. When the powder layers are sequentially stacked and sequentially receive the energy beams provided by the energy source to achieve additive manufacturing, the temperature control device may continually heat the powder layers to force the powder layers to implement the additive manufacturing in a same temperature range. In this way, when the powder layer stacked on the top are sintered and shaped, a shaping temperature thereof is not unexpectedly increased due to the remaining warmth of the lower processed powder layers, so as to avoid inconsistence of the material properties of each of the layer structures of the 3D object due to a difference of the processing temperature, and accordingly guarantee the manufacturing quality. Moreover, the temperature control device may control the shaping temperature of the powder layers according to a material type of the powder layers, such that the 3D object may have an expected material property. Moreover, based on the heating effect of the temperature control device, cooling down of the processed powder layers is not excessively fast to accumulate excessive thermal stress, so as to avoid warping of the product to influence the subsequent stacking and processing of the powder layers, and further improve the manufacturing quality.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an additive manufacturing apparatus according to an embodiment of the invention.

FIG. 2 is a flowchart illustrating an additive manufacturing method according to an embodiment of the invention.

FIG. 3 is a block diagram of partial components of the additive manufacturing apparatus of FIG. 1.

FIG. 4 is a block diagram of partial components of the additive manufacturing apparatus of FIG. 1.

### DESCRIPTION OF EMBODIMENTS

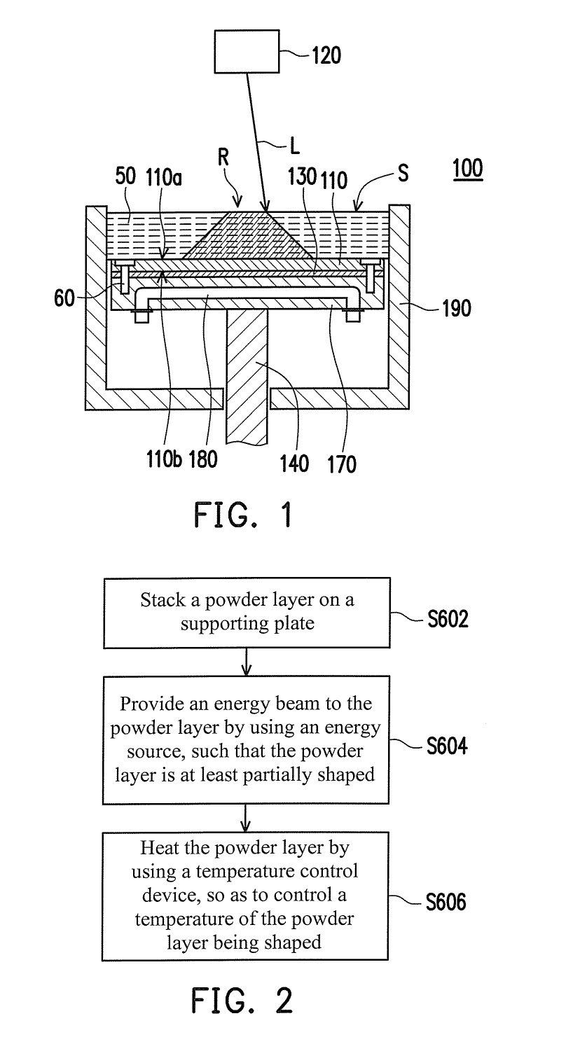

FIG. 1 is a schematic diagram of an additive manufacturing apparatus according to an embodiment of the invention. Referring to FIG. 1, the additive manufacturing apparatus 100 of the present embodiment includes a supporting plate 110 and an energy source 120. A plurality of powder layers 50 is adapted to be stacked on the supporting plate 110 in sequence, and the energy source 120 is adapted to provide energy beams L to the powder layers 50 in sequence, such that each of the powder layers 50 is at least partially shaped. The energy beams provided by the energy source 120 are, for example, laser, electron beams or other suitable energy beams, which is not limited by the invention. Each of the powder layers 50, for example, includes a plurality of metal powders or other powders with a suitable type of material, which is not limited by the invention.

In FIG. 1, a plurality of powder layers 50 has been stacked on the supporting plate 110, and a working plane S is aligned to the powder layer 50 on the top. The additive manufacturing apparatus 100 of the invention may include an elevating device 140, and the elevating device 140 is adapted to drive the supporting plate 110 and the powder layers 50 thereon to descend relative to the working plane S along with increase of the amount of the stacked powder layers 50, such that the subsequently provided powder layer 50 can be stacked on the supporting plate 110 and receive the energy beam L provided by the energy source 120 at the working surface S. In the present embodiment, the elevating device 140, for example, drives the supporting plate 110 to ascend and descend through screw actuation, though the invention is not limited thereto, and in other embodiments, the elevating device 140 may adopt other driving methods to drive the supporting plate 110 to ascend and descend.

In detail, each of the powder layers 50 is adapted to receive the energy beam L provided by the energy source 120 before being covered by another powder layer 50, such that the powder of the powder layer 50 within a predetermined 2D area can be melted and shaped by the energy beam L. Then the elevating device 140 descends the powder layer 50 to be below the working plane S, and another powder layer 50 covers on the aforementioned powder layer 50, and is also melted and shaped by the energy beam L provided by the energy source 120. According to the above method, a plurality of the powder layers 50 is sequentially processed to manufacture a 3D object with a predetermined 3D shape. In FIG. 1, a slash area R in the powder layers 50 schematically represents the predetermined 2D area and the predetermined 3D shape.

As shown in FIG. 1, the additive manufacturing apparatus 100 of the present embodiment further includes a temperature control device 130. The supporting plate 110 has an upper surface 110a and a lower surface 110b opposite to each other, where the upper surface 110a is adapted to carry the powder layers 50, and the temperature control device 130 is disposed on the lower surface 110b. When each of the powder layers 50 receives the energy beam L provided by the energy source 120 before being covered by another powder layer 50, the temperature control device 130 continually heats the powder layers 50 stacked on the supporting plate 110 to control a temperature of each of the powder layers 50 being shaped and decrease a cooling rate of each of the shaped powder layers 50. In the present embodiment, the temperature control device 130, for example, includes a resistive heating plate, and the powder layers 50 are heated by using the resistive heating plate, though in other embodiments, the temperature control device 130 can also be other suitable type of heating device, which is not limited by the invention. Moreover, a configuration position of the temperature control device is also not limited by the invention, and in other embodiments, the temperature control device 130 can be configured at other suitable position of the additive manufacturing apparatus 100 according to an actual requirement.

A flow of an additive manufacturing method executed by the additive manufacturing apparatus of the embodiment is as follows. A plurality of powder layers 50 is stacked on the supporting plate 110 in sequence, and during a process of stacking the powder layers 50 on the supporting plate 110, the energy source 120 provides energy beams L to the powder layers 50 in sequence, such that each of the powder layers 50 is at least partially shaped. Moreover, during the process of providing the energy beams L to the powder layers 50, the powder layers 50 are heated by using the temperature control device 130, so as to control the temperature of each of the powder layers 50 being shaped. The flow of the additive manufacturing method is described in detail below with reference of a flowchart.

FIG. 2 is a flowchart illustrating an additive manufacturing method according to an embodiment of the invention. Referring to FIG. 2, first, a powder layer is stacked on a supporting plate (step S602). An energy beam is provided to the powder layer by using an energy source, such that the powder layer is at least partially shaped (step S604). The powder layer is heated by using a temperature control device, so as to control a temperature of the powder layer being shaped (step S606). Then, the steps S602-S606 are repeated to sequentially shape the powder layers until manufacturing of the predetermined 3D object is completed.

According to the aforementioned operation method, when the powder layers 50 are sequentially stacked and sequentially receive the energy beams L provided by the energy source 120 to implement the additive manufacturing, the temperature control device 130 may continually heat the powder layers 50 to force the powder layers 50 to implement the additive manufacturing in a same temperature range. In this way, when the powder layers 50 stacked on the top are shaped, a shaping temperature thereof is not unexpectedly increased due to the remaining warmth of the lower processed powder layers 50, so as to avoid inconsistence of the material properties of each of the layer structures of the 3D object due to a difference of the processing temperature, and accordingly guarantee the product quality. Moreover, the temperature control device may control the shaping temperatures of the powder layers 50 according to a material type of the powder layers 50, such that the 3D object may have an expected material property. Moreover, based on the heating effect of the temperature control device 130, cooling down of the processed powder layers 50 is not excessively fast to accumulate excessive thermal stress, so as to avoid warping of the product to influence the subsequent stacking and processing of the powder layers 50, and further improve the manufacturing quality.

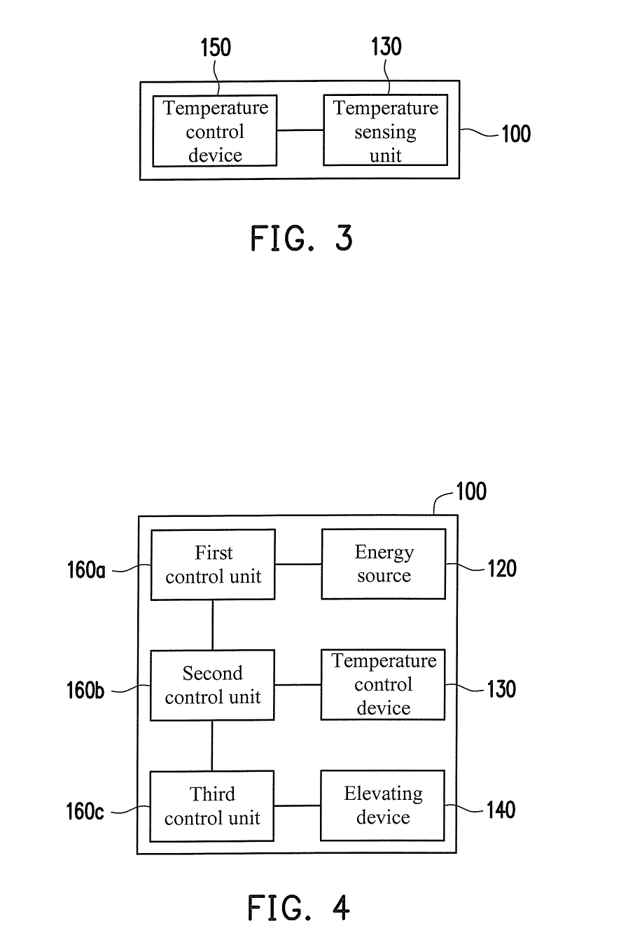

FIG. 3 is a block diagram of partial components of the additive manufacturing apparatus of FIG. 1. Referring to FIG. 3, the additive manufacturing apparatus 100 of the present embodiment further includes a temperature sensing unit 150. The temperature sensing unit 150 is adapted to sense a temperature of top one of the powder layers 50, and the temperature control device 130 takes the temperatures of the top one of the powder layers 50 sensed by the temperature sensing unit 150 as feed back temperatures to pre-heat the powder layers 50 to a predetermined temperature range. The predetermined temperature range is, for example, 400-600 degrees centigrade or other suitable temperature range, which is not limited by the invention. For example, the melting point of titanium alloy is 1630° C., so the predetermined temperature is designed below 70% of melting point, between 40% and 50% is better, so that the temperature gradient can be decreased, and accelerate the process.

FIG. 4 is a block diagram of partial components of the additive manufacturing apparatus of FIG. 1. Referring to FIG. 4, the additive manufacturing apparatus 100 of the present embodiment includes a first control unit 160a, a second control unit 160b and a third control unit 160c, where the first control unit 160a, the second control unit 160b and the third control unit 160c are respectively adapted to control operations of the energy source 120, the temperature control device 130 and the elevating device 140. Further, the first control unit 160a, the second control unit 160b and the third control unit 160c are, for example, control circuits in an automatic control system and operate in collaboration to drive the energy source 120, the temperature control device 130 and the elevating device 140 to implement the additive manufacturing through a predetermined automatic flow.

Referring to FIG. 1, the additive manufacturing apparatus 100 of the present embodiment includes a bottom plate 170 and a cooling device 180. The bottom plate 170 is configured to carry the temperature control device 130 and the supporting plate 110, and the elevating device 140 is connected to the bottom plate 170 to drive the bottom plate 170, the temperature control device 130 and the supporting plate 110 to commonly ascend and descend. The cooling device 180 is, for example, a waterway of a cooling water and is disposed in the bottom plate 170, which is used for accelerating a cooling rate of the powder layers 50 by using the cooling water in the waterway at an appropriate moment according to an actual requirement. In other embodiment, the cooling device 180 can also be disposed at other positions of the additive manufacturing apparatus 100 according to an actual requirement, which is not limited by the invention.

The additive manufacturing apparatus 100 of the present embodiment includes a containing tank 190, where the supporting plate 110, the temperature control device 130 and the bottom plate 170 are disposed in the containing tank 190, and the containing tank 190 is adapted to contain the powder layers 50 on the supporting plate 110, so as to avoid the powder of the powder layers 50 to unexpectedly drop off from the supporting plate 110 during the processing process. Moreover, the supporting plate 110 and the temperature control device 130 of the present embodiment are, for example, fixed on the bottom plate 170 through locking members 60, though the invention is not limited thereto, and the supporting plate 110 and the temperature control device 130 can be fixed through other suitable methods.

In summary, in the invention, the temperature control device is applied to control a processing temperature of each of the powder layers. When the powder layers are sequentially stacked and sequentially receive the energy beams provided by the energy source to achieve additive manufacturing, the temperature control device may continually heat the powder layers to force the powder layers to implement the additive manufacturing in a same temperature range. In this way, when the powder layers stacked on the top are shaped, a shaping temperature thereof is not unexpectedly increased due to the remaining warmth of the lower processed powder layers, so as to avoid inconsistence of the material properties of each of the layer structures of the 3D object due to a difference of the processing temperature, and accordingly guarantee the product quality. Moreover, the temperature control device may control the shaping temperatures of the powder layers according to a material type of the powder layers, such that the 3D object may have an expected material property. Moreover, based on the heating effect of the temperature control device, cooling down of the processed powder layers is not excessively fast to accumulate excessive thermal stress, so as to avoid warping of the product to influence the subsequent stacking and processing of the powder layers, and further improve the manufacturing quality. Moreover, the cooling device can be applied to accelerate a cooling rate of the powder layers at an appropriate moment, so as to improve the operation efficiency of the additive manufacturing apparatus.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An additive manufacturing method, comprising:
stacking a plurality of powder layers on a supporting plate in sequence;
providing energy beams to the powder layers in sequence by using an energy source, such that each of the powder layers is at least partially shaped; and
pre-heating the powder layers by using a temperature control device, so as to control a temperature of each of the powder layers being shaped.

2. The additive manufacturing method as claimed in claim 1, wherein the step of heating the powder layers by using the temperature control device comprises:
continually heating each of the powder layers by using the temperature control device, so as to decrease a cooling rate of each of the shaped powder layers.

3. The additive manufacturing method as claimed in claim 1, wherein the step of providing the energy beams to the powder layers in sequence by using the energy source comprises:
receiving the energy beam provided by the energy source by each of the powder layers before the powder layer is covered by another one of the powder layers, and simultaneously heating the powder layer by the temperature control device.

4. The additive manufacturing method as claimed in claim 1, wherein the supporting plate has an upper surface and a lower surface opposite to each other, the temperature control device is disposed on the lower surface, and the step of stacking the powder layers on the supporting plate in sequence comprises:
carrying the powder layers by using the upper surface.

5. The additive manufacturing method as claimed in claim 1, wherein the temperature control device comprises a resistive heating plate, and the step of heating the powder layers by using the temperature control device comprises:
heating the powder layers by using the resistive heating plate.

6. The additive manufacturing method as claimed in claim 1, wherein the step of heating the powder layers by using the temperature control device comprises:
sensing a temperature of top one of the powder layers by using a temperature sensing unit; and
heating the powder layers by using the temperature control device according to the temperatures of the top one of the powder layers.

7. The additive manufacturing method as claimed in claim 1, further comprising:
driving the supporting plate to ascend and descend relative to a working plane by using an elevating device, such that each of the powder layers is stacked and receives the energy beam provided by the energy source at the working plane.

8. The additive manufacturing method as claimed in claim 7, further comprising:
respectively controlling the energy source, the temperature control device and the elevating device by using a first control unit, a second control unit and a third control unit.

9. The additive manufacturing method as claimed in claim 1, further comprising:
cooling the powder layers by using a cooling device.

10. The additive manufacturing method as claimed in claim 1, further comprising:
containing the powder layers on the supporting plate by using a containing tank.
